(19) United States
(12) Patent Application Publication
(10) Pub. No.: US 2025/0368271 A1
(43) Pub. Date: Dec. 4, 2025

(54) VEHICLE

(71) Applicant: KAWASAKI MOTORS, LTD., Hyogo (JP)

(72) Inventors: Chase NICKLE, Lincoln, NE (US); Justin OLSON, Lincoln, NE (US); John RAMEY, Lincoln, NE (US); Loran FORTIK, Lincoln, NE (US)

(73) Assignee: KAWASAKI MOTORS, LTD., Hyogo (JP)

(21) Appl. No.: 18/680,576

(22) Filed: May 31, 2024

(51) Int. Cl. B62D 25/07

(52) U.S. Cl. CPC B62D 25/07

(57) ABSTRACT

A utility vehicle 100 includes a front roof 50 and a rear roof 60 located rearward of the front roof 50, a rear end portion 51 of the front roof 50 overlaps a front end portion 61 of the rear roof 60 in a top-bottom direction, and the rear end portion 51 is located below the front end portion 61.

### FIELD

The technique disclosed here relates to a vehicle.

### BACKGROUND

U.S. Patent Application Publication No. 2022/0348265 discloses a vehicle. The vehicle includes a roof.

### SUMMARY

Regarding such vehicles as described above, in the case of manufacturing different types of vehicles, for example, vehicles with different lengths in the front-rear direction, separate roofs need to be prepared for different vehicle types, which is troublesome.

It is therefore an object of the technique disclosed here to easily fit multiple vehicle types.

A vehicle disclosed here includes: a front roof; and a rear roof located rearward of the front roof, a rear end portion of the front roof overlaps a front end portion of the rear roof in a top-bottom direction, and the rear end portion is located below the front end portion.

A vehicle disclosed here includes: a front roof; a rearward located rearward of the front roof; and a fixing member attached to at least one of the front roof and the rear roof and extending in a longitudinal direction, the fixing member allowing a rod member to be fixed thereto, the rod member includes a fitting groove extending in the longitudinal direction and allowing the rod member to be fitted therein.

The vehicle easily fits various vehicle types.

### BRIEF DESCRIPTION OF THE DRAWINGS

FIG. 1 is a left side view of a utility vehicle according to an embodiment.

FIG. 2 is a left side view of the utility vehicle in which a soft cab enclosure is omitted.

FIG. 3 is a plan view of a roof when seen from above.

FIG. 4 is a perspective view of a front roof when seen from above the left rear.

FIG. 5 is a cross-sectional view taken along line V-V in FIG. 4.

FIG. 6 is a cross-sectional view taken along line VI-VI in FIG. 3.

FIG. 7 is a perspective view of the soft cab enclosure attached to fixing members when seen from below the left rear.

FIG. 8 is a perspective view of the fixing members attached to the roof when seen from below the left rear.

FIG. 9 is a cross-sectional view illustrating an attachment state of the soft cab enclosure and the fixing members in the front roof.

FIG. 10 is a plan view of a front roof of a utility vehicle according to a first variation when seen from above.

FIG. 11 is a cross-sectional view taken along line XI-XI in FIG. 10.

FIG. 12 is a perspective view of a utility vehicle according to a second variation when seen from above the left front.

### DESCRIPTION OF EMBODIMENTS

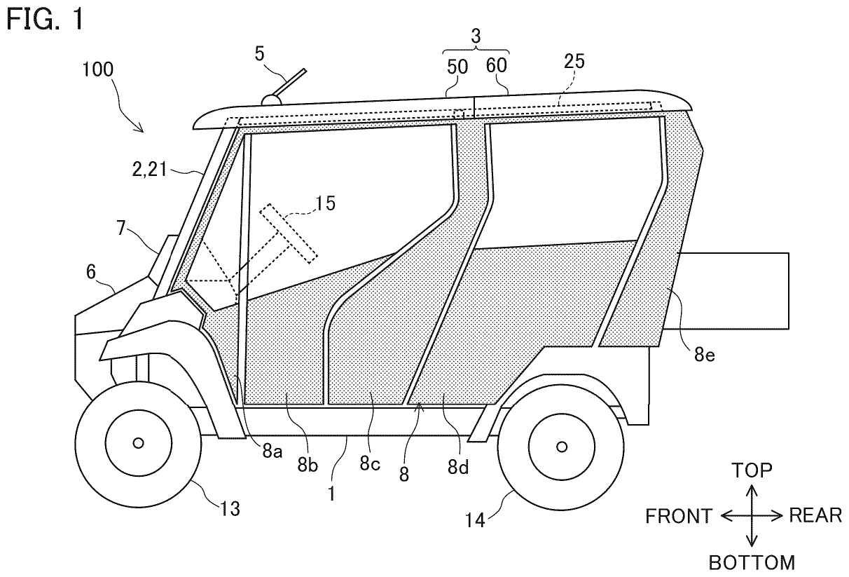

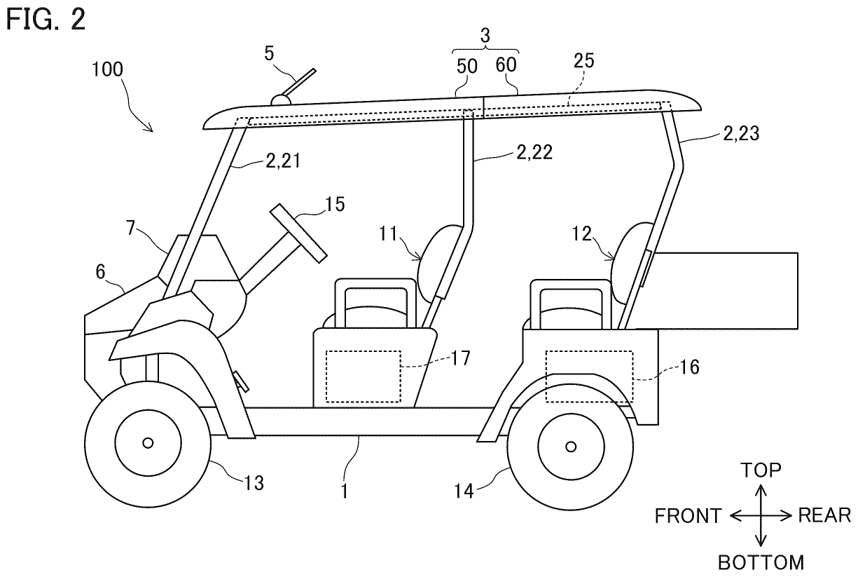

An exemplary embodiment will be described in detail hereinafter with reference to the drawings. FIG. 1 is a left side view of a utility vehicle 100. FIG. 2 is a left side view of the utility vehicle 100 in which soft cab enclosures 8 are omitted. Hereinafter, the utility vehicle 100 will also be referred to simply as a “vehicle 100.”

The vehicle 100 corresponds to one example of a vehicle disclosed here. The vehicle 100 is a vehicle intended to travel at low speed in a limited area. Examples of the limited area include a limited community area, a private road, and a private property (e.g., a golf course and a park). The limited community area refers to an area available for use by local residents. The community area is, for example, an area including houses and public facilities (e.g., schools, hospitals, etc.), and is an area where the vehicle 100 not intended to travel on a public road is permitted to travel at low speed. The low speed refers to a speed up 20 mph to 30 mph, for example. The vehicle 100 may travel at a speed of 20 mph or less or 30 mph or more. The vehicle 100 includes, for example, a personal transport vehicle (PTV). The PTV includes a golf cart. The vehicle 100 may be other golf carts such as a low speed vehicle (LSV).

In this disclosure, components of the vehicle 100 will be described based on directions of the vehicle 100. Specifically, “front” refers to the front of the vehicle 100 in the vehicle front-rear direction, and “rear” refers to the rear of the vehicle 100 in the vehicle front-rear direction. “Left” refers to the left of the vehicle 100 when seeing forward, and “right” refers to the right of the vehicle 100 when seeing forward. The “vehicle width direction” refers to the vehicle width direction of the vehicle 100, in other words, means the left-right direction of the vehicle 100 and will be sometimes referred to as a “left-right direction.” An “inner side in the vehicle width direction” refers to a cabin side in the vehicle width direction, and an “outer side in the vehicle width direction” refers to a vehicle outer side in the vehicle width direction. The expression “a member extends or expands in a direction” herein includes not only a case where the member extends or expands strictly in parallel with the direction” but also a case where the member extends or expands generally in the direction.”

The vehicle 100 includes a front roof 50 and a rear roof 60 located rearward of the front roof 50. The front roof 50 and the rear roof 60 define a roof 3. The roof 3 expands in the front-rear direction and the left-right direction to cover a cabin from above. The roof 3 may be made of a metal or a resin.

The vehicle 100 further includes a body frame 1, pillars 2 attached to the body frame 1 and extending in the top-bottom direction, and soft cab enclosures 8 attached to the roof 3.

The body frame 1 is a portion serving as a framework of a lower portion of the vehicle 100. The body frame 1 is constituted by combining metal pipe parts, metal plate parts, or casted parts, for example. The body frame 1 includes longitudinal frames extending in the front-rear direction and arranged in the vehicle width direction, and lateral frames extending in the vehicle width direction and arranged in the front-rear direction.

The pillars 2 include front pillars 21, center pillars 22, and rear pillars 23. The front pillars 21 will also be referred to as A pillars, the center pillars 22 will also be referred to as B pillars, and the rear pillars 23 will also be referred to as C pillars. When the front pillars 21, the center pillars 22, and the rear pillars 23 are not distinguished from one another, these pillars are referred to simply as “pillars 2.”

Lower portions of the pillars 2 are supported by the body frame 1, and upper portions of the pillars 2 support the roof 3. The pillars 2 are hollow cylinders. A cross section of each of the pillars 2 in a direction orthogonal to the axis thereof is circular. The pillars 2 may be made of a metal or a resin.

The front pillars 21, the center pillars 22, and the rear pillars 23 are arranged in this order from the front toward the rear. The front pillars 21 are individually disposed at the left and right in the vehicle width direction. Similarly, the center pillars 22 are individually disposed at the left and right in the vehicle width direction, and the rear pillars 23 are individually disposed at the left and right in the vehicle width direction. The front pillars 21 and the center pillars 22 define a front cabin part. The center pillars 22 and the rear pillars 23 define a rear cabin part.

The front pillars 21, the center pillars 22, and the rear pillars 23 are coupled to side rails 25 in upper portions thereof. The side rails 25 extend in the front-rear direction. The side rails 25 are individually disposed at the left and right in the vehicle width direction.

The roof 3 are located on top of the front pillars 21, the center pillars 22, the rear pillars 23, and the side rails 25. The roof 3 extends from the outer side of the left side rail 25 to the outer side of the right side rail 25 in the vehicle width direction. The roof 3 extends from the outer sides of the front pillars 21 to the outer sides of the rear pillars 23 in the front-rear direction.

The front roof 50 is located on top of the front pillars 21 and the center pillars 22. That is, the front roof 50 is located above the front cabin part. The rear roof 60 is located on top of the rear pillars 23. That is, the rear roof 60 is located above the rear cabin part.

The front roof 50 descends from the rear toward the front when seen in the vehicle width direction. That is, the front roof 50 tilts relative to the horizontal plane such that the height at the front end is lower than the height at the rear end. The rear roof 60 descends from the rear toward the front when seen in the vehicle width direction. That is, the rear roof 60 tilts relative to the horizontal plane such that the height at the front end is lower than the height at the rear end.

The soft cab enclosures 8 shield the cabin from the outside of the vehicle. The soft cab enclosures 8 may be made of a resin or rubber.

Specifically, the soft cab enclosures 8 are individually located at the left and right in the vehicle width direction. The left soft cab enclosure 8 covers the left sides of the front and rear cabin parts. The right soft cab enclosure 8 covers the right sides of the front and rear cabin parts. Although FIG. 1 shows the left soft cab enclosure 8 of the vehicle 100, the right side of the vehicle 100 has a similar configuration. FIG. 1 shows the soft cab enclosure 8 by dots for convenience.

Each of the soft cab enclosures 8 includes partitions 8a through 8e that are separated from one another by slits. In this example, each of the soft cab enclosures 8 includes five partitions 8a through 8e. Specifically, each soft cab enclosure 8 includes the first partition 8a, the second partition 8b, the third partition 8c, the fourth partition 8d, and the fifth partition 8e. The first partition 8a, the second partition 8b, the third partition 8c, the fourth partition 8d, and the fifth partition 8e are arranged in this order from the front toward the rear.

Upper ends of the partitions 8a through 8e are connected to one another. Portions of the partitions 8a through 8e below the upper ends thereof are separated from one another by slits. Accordingly, each of the partitions 8a through 8e is capable of being opened and closed in the portion below the upper end thereof. Passengers can get in and out of the cabin by opening the partitions 8a through 8e.

The lower ends of the first partition 8a, the third partition 8c, and the fifth partition 8e may be fixed to the body frame 1. In this case, the second partition 8b and the fourth partition 8d are capable of being opened and closed. The second partition 8b is located at a position that enables a passenger to easily get in and out of the front cabin part. The fourth partition 8d is located at a position that enables a passenger to easily get in and out of the rear cabin part. In this manner, only partitions at positions related to getting in and out of a passenger may be allowed to be opened and closed.

Each of the first partition 8a, the second partition 8b, and the fourth partition 8d includes a transparent window. That is, upper portions of the first partition 8a, the second partition 8b, and the fourth partition 8d are transparent, and lower portions of the first partition 8a, the second partition 8b, and the fourth partition 8d are opaque. This enables a passenger to visually recognize the outside of the vehicle through the windows. The third partition 8c and the fifth partition 8e have no windows and are opaque.

The vehicle 100 further includes front seats 11 and rear seats 12. The front seats 11 and the rear seats 12 are supported by the body frame 1. The front seats 11 are individually located at the left and right in the vehicle width direction, and the rear seats 12 are also individually located at the left and right in the vehicle width direction. The front seats 11 are located forward of the rear seats 12. The front seats 11 are located in the front cabin part. The rear seats 12 are located in the rear cabin part.

The vehicle 100 further includes front wheels 13 and rear wheels 14. The front wheels 13 support a front portion of the body frame 1. The rear wheels 14 support a rear portion of the body frame 1. The front wheels 13 are individually located at the left and right in the vehicle width direction, and the rear wheels 14 are individually located at the left and right in the vehicle width direction. That is, the vehicle 100 is a four-wheeled vehicle.

The vehicle 100 further includes a panel. The panel covers parts supported by the body frame 1. The panel defines an appearance of the vehicle 100. The panel includes a hood 6 and a dashboard 7.

The hood 6 is attached to a front portion of the body frame 1. The hood 6 is located outside the vehicle The hood 6 corresponds to a top cover of a front portion of the vehicle 100.

The dashboard 7 is attached to the body frame 1 behind the hood 6. The dashboard 7 is located mainly in the cabin. The dashboard 7 faces the front seats 11. Drink holders and a speedometer are located in an upper portion of the dashboard 7. A glove box is located in a lower portion of the dashboard 7.

A steering wheel 15 is located behind the dashboard 7. A driver operates the steering wheel 15 to thereby change the angle of the front wheels 13 to the axle and change the traveling direction of the vehicle 100.

The vehicle 100 further includes a motor 16 and a battery 17. The motor 16 is an electric motor that converts electric energy to rotation movement for traveling. The battery 17 stores electric energy and supplies the electric energy to the motor 16. The motor 16 is located under the rear seats 12. The battery 17 is located under the front seats 11. The motor 16 may be an internal combustion engine. In this case, the vehicle 100 includes a fuel tank.

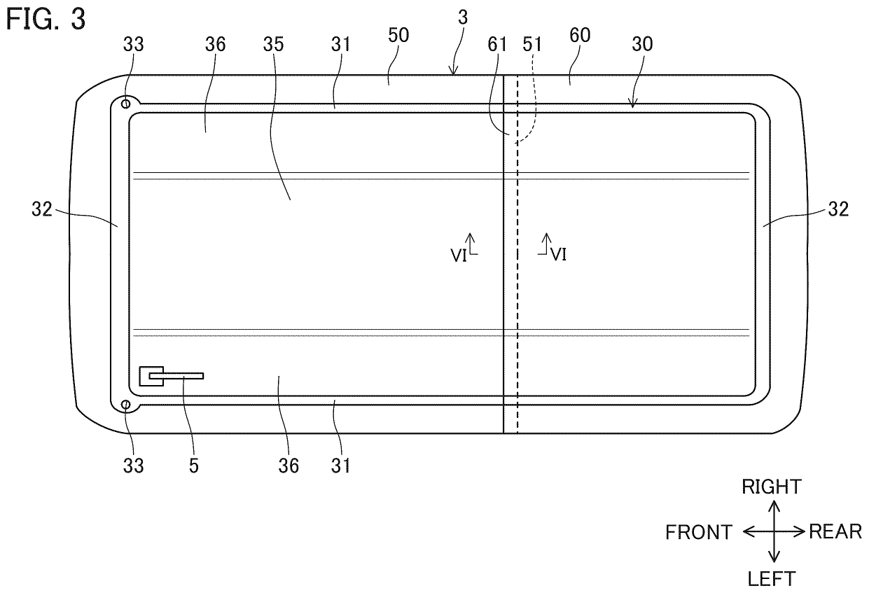

FIG. 3 is a plan view of the roof 3 when seen from above. The roof 3 includes a drain channel 30 and drain holes 33. The drain channel 30 and the drain holes 33 are located on the upper surface of the roof 3.

The drain channel 30 is annular in a plan view. The drain channel 30 includes first grooves 31 extending in the front-rear direction and second grooves 32 extending in the left-right direction. The first grooves 31 are individually located at the left and the right. The second grooves 32 are individually located at the front and the rear. The left and right first grooves 31 and the front and rear second grooves 32 are connected in an annular pattern.

The first grooves 31 are located across the front roof 50 and the rear roof 60. Front portions of the front first grooves 31 are located on the front roof 50. Rear portions of the first grooves 31 are located on the rear roof 60.

The drain holes 33 are located at the bottom of the drain channel 30. The drain holes 33 are located in a left front portion and a right front portion. The left drain hole 33 is located in a portion where the left first groove 31 and the front second groove 32 are connected. The right drain hole 33 is located in a portion where the right first groove 31 and the front second groove 32 are connected. The drain holes 33 are located in the front roof 50. The drain holes 33 face and communicate with opening holes in upper ends of the front pillars 21, for example.

The bottoms of the first grooves 31 descend from the rear toward the front. The bottoms of the second grooves 32 descend from the center in the vehicle width direction outward in the vehicle width direction. That is, the bottoms of the first grooves 31 and the bottoms of the second grooves 32 descend toward the drain holes 33. Accordingly, rainwater flowing along the first grooves 31 and the second grooves 32 moves toward the drain holes 33 under its own weight. Rainwater that has reached the drain holes 33 enters the inside of the front pillars 21 from the opening holes in the upper ends of the front pillars 21 and is discharged to the outside from the opening holes in the lower ends of the front pillars 21.

The upper surface of the roof 3 includes a first surface 35 and second surfaces 36. The first surface 35 and the second surfaces 36 are located inside the annular drain channel 30 in a plan view. The first surface 35 and the second surfaces 36 expand in the front-rear direction. The first surface 35 and the second surfaces 36 are located across the front roof 50 and the rear roof 60.

The first surface 35 is located at the center in the vehicle width direction. The second surfaces 36 are located outside the left and right sides of the first surface 35. The first surface 35 is located below the second surfaces 36. The first surface 35 descends from the rear toward the front. The second surfaces 36 descend from the center in the vehicle width direction outward in the vehicle width direction. Accordingly, rainwater flowing along the first surface 35 moves toward the front second groove 32 under its own weight. Rainwater flowing along the second surfaces 36 moves toward the first grooves 31 under its own weight.

The vehicle 100 further includes an antenna 5. The antenna 5 is attached to the upper surface of the front roof 50. The antenna 5 is located on a front left portion of the front roof 50. The antenna 5 is located inside the annular drain channel 30 in a plan view. The antenna 5 is located near a portion where the left first groove 31 and the front second groove 32 are connected in a plan view.

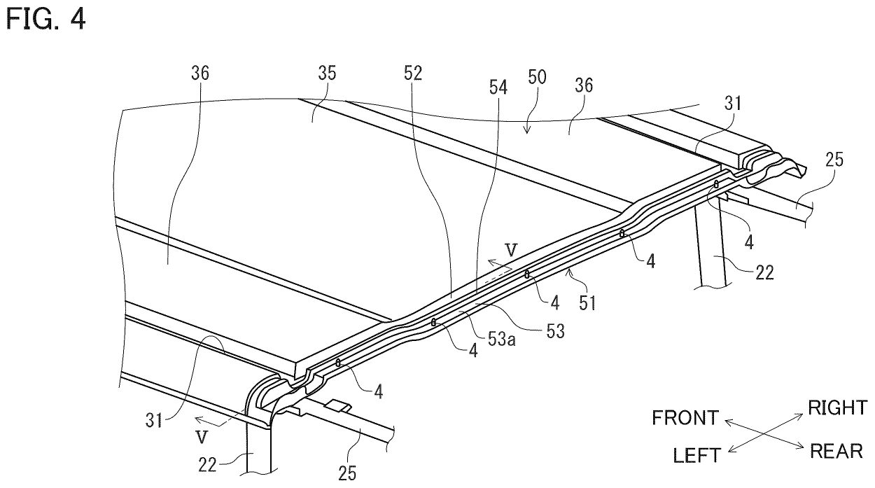

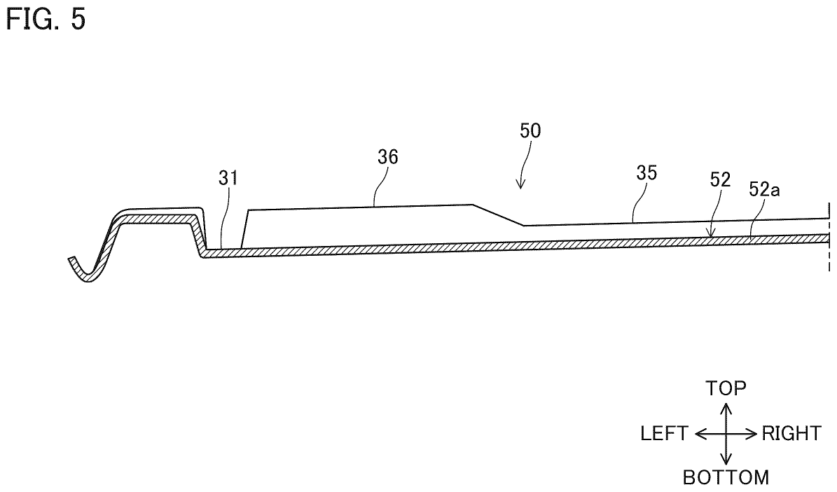

FIG. 4 is a perspective view of the front roof 50 when seen from above the left rear. FIG. 5 is a cross-sectional view taken along line V-V in FIG. 4. A rear end portion 51 of the front roof 50 has a drain ditch 52 that is open upward and extends in the vehicle width direction. Although FIG. 5 shows a left portion of the front roof 50 in the vehicle width direction, a right portion of the front roof 50 in the vehicle width direction has a similar structure.

The drain ditch 52 is connected to the first grooves 31 at outer sides in the vehicle width direction. The drain ditch 52 includes a bottom wall 52a, and the bottom wall 52a is connected to the bottoms of the first grooves 31. The bottom wall 52a is located below the first surface 35 and the second surfaces 36.

The bottom wall 52a descends from the center in the vehicle width direction outward in the vehicle width direction. That is, the bottom wall 52a tilts relative to the horizontal plane such that the height at the outer ends in the vehicle width direction is lower than the height at the center in the vehicle width direction. In this example, the bottom wall 52a tilts such that the center in the vehicle width direction is highest.

The rear end portion 51 of the front roof 50 further includes an attachment groove 53 and a partition 54. The attachment groove 53 is located rearward of the drain ditch 52. The attachment groove 53 is open upward and extends in the vehicle width direction. The partition 54 partitions the drain ditch 52 and the attachment groove 53. The partition 54 extends in the vehicle width direction.

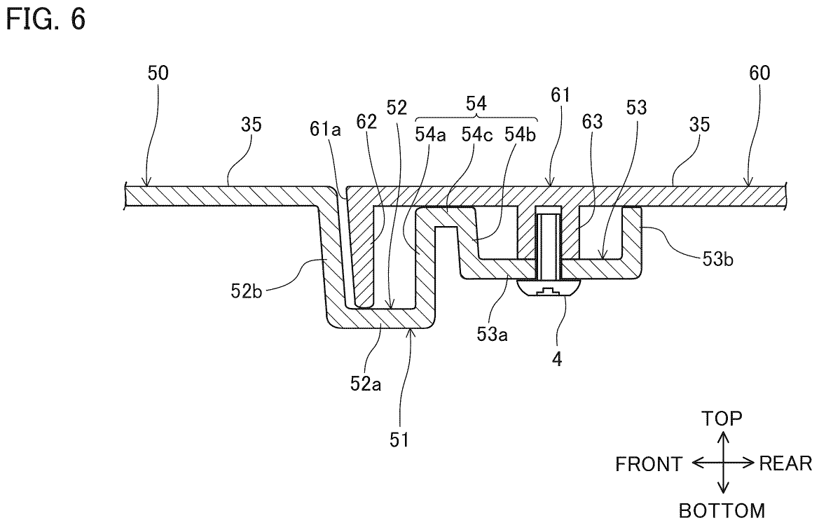

FIG. 6 is a cross-sectional view taken along line VI-VI in FIG. 3. The rear end portion 51 of the front roof 50 overlaps a front end portion 61 of the rear roof 60 in the top-bottom direction. The rear end portion 51 is located below the front end portion 61.

The drain ditch 52 of the rear end portion 51 overlaps a front end 61a of the front end portion 61 in the top-bottom direction. Specifically, the drain ditch 52 includes a side wall 52b located forward of the bottom wall 52a and rising from the bottom wall 52a. The side wall 52b is connected to the first surface 35. The front end of the front end portion 61 includes a projection wall 62 projecting downward. The front surface of the projection wall 62 corresponds to the front end 61a. The projection wall 62 is inserted in the drain ditch 52. The projection wall 62 faces the side wall 52b. The lower end of the projection wall 62 is in contact with the bottom wall 52a.

The attachment groove 53 includes a bottom wall 53a, and a side wall 53b located rearward of the bottom wall 53a and rising from the bottom wall 53a. The side wall 53b is in contact with the front end portion 61. The bottom wall 53a of the attachment groove 53 is located above the bottom wall 52a of the drain ditch 52.

The partition 54 includes a first side wall 54a defining the drain ditch 52, a second side wall 54b defining the attachment groove 53, and a coupling wall 54c coupling the first side wall 54a and the second side wall 54b to each other.

The first side wall 54a rises from the bottom wall 52a of the drain ditch 52. The first side wall 54a is a part of the partition 54 and is also a part of the drain ditch 52. Specifically, the first side wall 54a defines a rear side wall of the drain ditch 52.

The second side wall 54b rises from the bottom wall 53a of the attachment groove 53. The second side wall 54b is a part of the partition 54 and is also a part of the attachment groove 53. Specifically, the second side wall 54b defines a front side wall of the attachment groove 53.

The first side wall 54a and the second side wall 54b face each other in the front-rear direction. The first side wall 54a and the second side wall 54b are separated from each other in the front-rear direction. A gap that is open in a direction opposite to the front end portion 61 is defined between the first side wall 54a and the second side wall 54b.

The coupling wall 54c is located below the first surface 35. The coupling wall 54c is in contact with the front end portion 61.

The vehicle 100 further includes fastening members 4 fastening the rear end portion 51 and the front end portion 61. The fastening members 4 are located rearward of the drain ditch 52. The fastening members 4 are, for example, bolts. The fastening members 4 penetrate the bottom wall 53a of the attachment groove 53 to be tightened to the front end portion 61.

Specifically, the front end portion 61 includes bosses 63 projecting downward from the lower surface. The bosses 63 are inserted in the attachment groove 53. The lower ends of the bosses 63 is in contact with the bottom wall 53a. The fastening members 4 penetrate the bottom wall 53a from below the bottom wall 53a to be tightened to the bosses 63. That is, head portions of the fastening members 4 are located at the lower surface of the bottom wall 53a and screw portions of the fastening members 4 are screwed to holes in the bosses 63. The holes of the bosses 63 define screw grooves beforehand, but the screw portions of the fastening members 4 may define the screw grooves with tightening of the fastening members 4.

The vehicle 100 includes the fastening members 4. In this example, the vehicle 100 includes five fastening members 4, as illustrated in FIG. 4. The fastening members 4 are arranged along the vehicle width direction on the bottom wall 53a of the attachment groove 53.

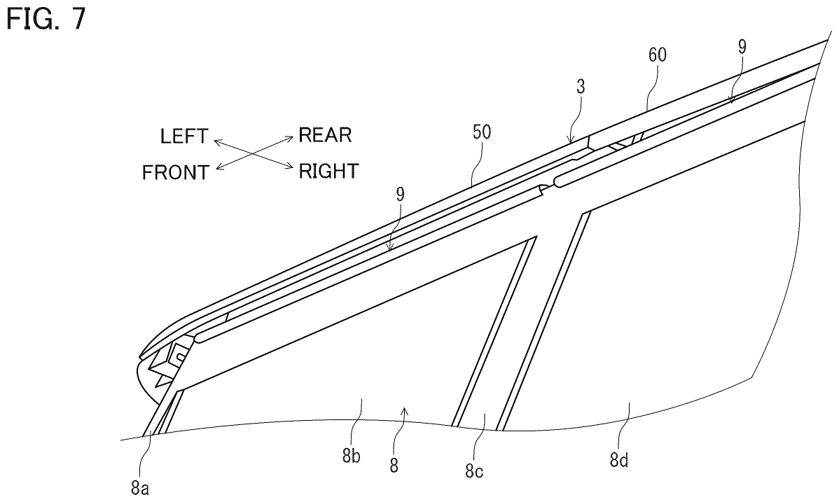

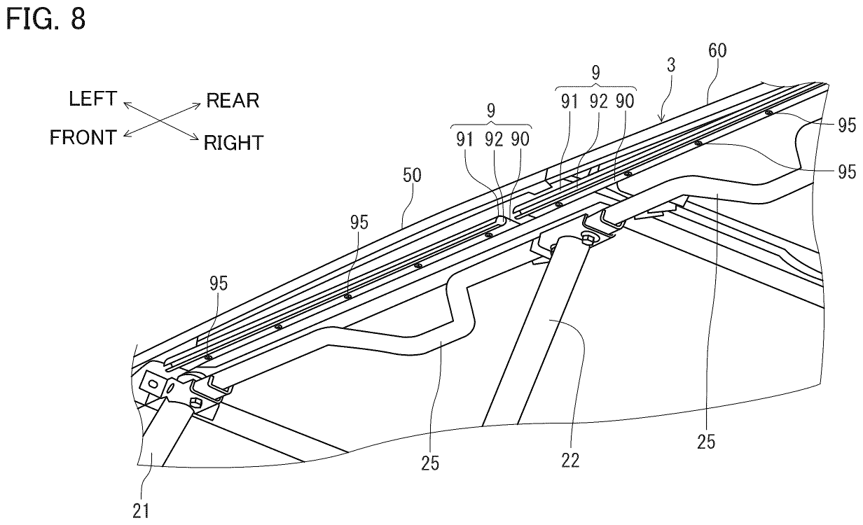

FIG. 7 is a perspective view of the soft cab enclosure 8 attached to fixing members 9 when seen from below the left rear. FIG. 8 is a perspective view of the fixing members 9 attached to the roof 3 when seen from below the left rear. FIGS. 7 and 8 show the left soft cab enclosure 8 and the fixing members 9 at the left of the vehicle 100, and the right side of the vehicle 100 has a similar configuration.

The vehicle 100 further includes the fixing members 9 fixing the soft cab enclosures 8. The soft cab enclosures 8 are detachably attached to the fixing members 9. The fixing members 9 extend in the longitudinal direction. In this example, the fixing members 9 extend in the front-rear direction. The fixing members 9 may be made of a metal or a resin.

The fixing members 9 are individually attached to the front roof 50 and the rear roof 60. The fixing members 9 are located on the outer side portions of the roof 3 in the vehicle width direction. Specifically, the fixing members 9 are individually located at the front and the rear. The front fixing members 9 are attached to the front roof 50, and the rear fixing members 9 are attached to the front roof 50 and the rear roof 60.

Each of the fixing members 9 includes an attachment part 90 and a fitting part 91 attached to the attachment part 90. The attachment part 90 is a plate member extending in the longitudinal direction. The attachment part 90 is attached to the lower surface of the roof 3 with a bolt 95.

The fitting part 91 is a cylindrical member including a slit extending in the longitudinal direction. In this example, the fitting part 91 has a C-shaped cross section. The fitting part 91 includes a fitting groove 92 extending in the longitudinal direction. The upper end of the soft cab enclosure 8 is fitted in the fitting groove 92.

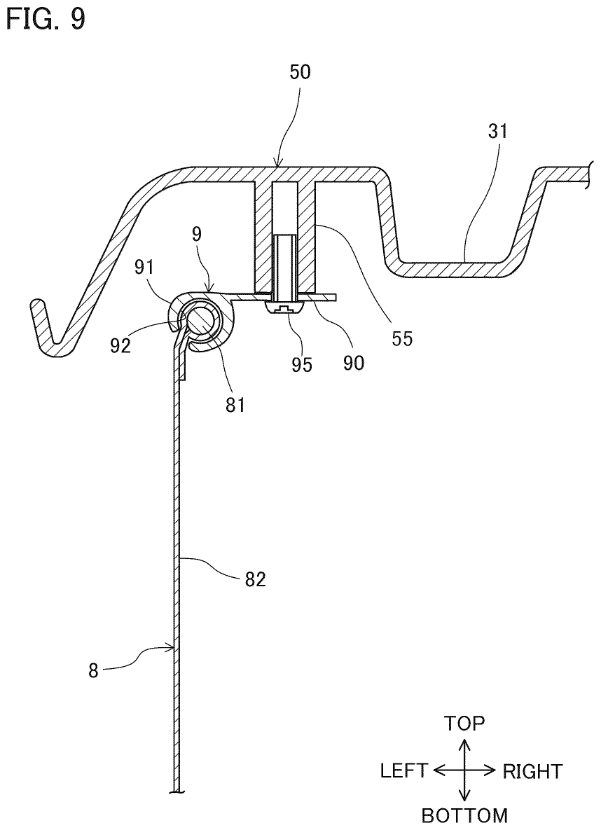

FIG. 9 is a cross-sectional view illustrating an attachment state of the soft cab enclosure 8 and the fixing member 9 in the front roof 50. Although FIG. 9 shows the soft cab enclosure 8 and the fixing member 9 in the front roof 50, the rear roof 60 has a similar configuration.

The front roof 50 includes a projection 55 located outward of the first groove 31 in the vehicle width direction and projecting downward. The attachment part 90 of the fixing member 9 is attached to the projection 55 through the bolt 95. Specifically, the bolt 95 penetrates the attachment part 90 from below the attachment part 90 to be tightened to the projection 55. That is, the head portion of the bolt 95 is located at the lower surface of the attachment part 90, and a screw portion of the bolt 95 is screwed to a hole in the projection 55. The hole of the projection 55 defines a screw groove beforehand, but the screw portion of the bolt 95 may define the screw groove with tightening of the bolt 95.

Each of the soft cab enclosures 8 includes a rod member 81 and a curtain 82 wrapped around the rod member 81. Specifically, the rod member 81 extends in the longitudinal direction. In this example, the rod member 81 extends in the front-rear direction. The rod member 81 may be made of a metal or a resin. The curtain 82 is wrapped around the rod member 81. In this example, an end portion of the curtain 82 is wrapped around the rod member 81, folded back, and stitched to a portion below the end portion of the curtain 82. The curtain 82 may be made of a resin or rubber.

The rod member 81 is fitted in the fitting groove 92. In other words, the fitting groove 92 allows the rod member 81 to be fitted therein, and the rod member 81 can be fitted to the fixing member 9. That is, the rod member 81 is fitted in the fitting groove 92, and the soft cab enclosure 8 is fixed to the fixing member 9. Specifically, a portion of the curtain 82 wrapped around the rod member 81 is fitted in the fitting groove 92 together with the rod member 81. The rod member 81 is inserted in the fitting groove 92 through an opening of the fitting groove 92 in the longitudinal direction and mounted to the fitting groove 92. The curtain 82 hangs down from the rod member 81 through the opening of the fitting groove 92, that is, the slit of the fitting part 91. The rod member 81 can be pulled out from the fitting groove 92 through the opening of the fitting groove 92 in the longitudinal direction.

Since the vehicle 100 includes the front roof 50 and the rear roof 60 as described above, the roof has a split structure. Accordingly, in the case of manufacturing different types of vehicles, for example, vehicles with different lengths in the front-rear direction, the front roof 50 or the rear roof 60 can be commonly used so that this structure can easily fit various vehicle types.

Specifically, if the vehicle roof is constituted by a single roof, in the case of manufacturing different types of vehicles, a single roof needs to be prepared for each of the different types of vehicles, which is troublesome.

On the other hand, since the roof has the split structure in this example, the roof of the vehicle can be fabricated by combining the front roof 50 and the rear roof 60, and this structure easily fits different vehicle types. For example, the front roof 50 is commonly used for different vehicle types, and the rear roof 60 is changed for each vehicle type. Alternatively, the rear roof 60 may be commonly used and the front roof 50 may be changed for each vehicle type.

In addition, the front roof 50 can be placed above the front cabin part and the rear roof 60 can be placed above the rear cabin part. Accordingly, the front roof 50 can be unitized with the front cabin part, and the rear roof 60 can be unitized with the rear cabin part. Thus, in manufacturing different types of vehicles, the front cabin part or the rear cabin part can be commonly used.

In addition, since the rear end portion 51 and the front end portion 61 overlap each other in the top-bottom direction, direct entry of rainwater into the cabin can be reduced. Specifically, even if rainwater enters between the front end 61a of the front end portion 61 and the rear end portion 51, rainwater is blocked by the rear end portion 51 and is less likely to enter the cabin directly.

Since the rear end portion 51 is located below the front end portion 61, in a case where each of the front roof 50 and the rear roof 60 descends from the rear toward the front, even if rainwater enters between the rear end portion 51 and the front end portion 61, entry of rainwater into the cabin can be reduced.

Specifically, if the rear end portion 51 is located above the front end portion 61, since the front end portion 61 descends from the rear toward the front, when rainwater enters between the rear end portion 51 and the front end portion 61, rainwater flows along the upper surface of the front end portion 61 under its own weight and enters the cabin from the front of the front end portion 61.

On the other hand, in the configuration in which the rear end portion 51 is located below the front end portion 61 as disclosed here, since the rear end portion 51 descends from the rear toward the front, when rainwater enters between the rear end portion 51 and the front end portion 61, rainwater tends to move forward of the rear end portion 51 under its own weight. This can reduce entry of rainwater into the cabin from the rear of the rear end portion 51.

In addition, since the drain ditch 52 of the rear end portion 51 overlaps the front end 61a of the front end portion 61 in the top-bottom direction, even when rainwater enters between the front end 61a of the front end portion 61 and the rear end portion 51, rainwater flows into the drain ditch 52 to be discharged along the vehicle width direction. This can further reduce entry of rainwater into the cabin.

Since the projection wall 62 is inserted in the drain ditch 52 and faces the side wall 52b, even when rainwater enters between the front end 61a of the front end portion 61 and the rear end portion 51, rainwater flows between the projection wall 62 and the side wall 52b to be guided to the drain ditch 52. This can further reduce entry of rainwater into the cabin.

Further, since the bottom wall 52a of the drain ditch 52 descends from the center in the vehicle width direction outward in the vehicle width direction, rainwater that has entered the drain ditch 52 can be more reliably guided to the outer sides in the vehicle width direction.

Since the drain ditch 52 is connected to the first grooves 31, rainwater that has entered the drain ditch 52 can be guided to the first grooves 31. Then, rainwater is discharged through the drain holes 33.

Since the fastening members 4 are located rearward of the drain ditch 52, even when rainwater enters between the front end portion 61 and the rear end portion 51, rainwater is blocked by the drain ditch 52 and entry of rainwater into the fastening members 4 is inhibited. This can prevent corrosion of the fastening members 4.

Furthermore, since the rear end portion 51 includes the partition 54, rainwater that has entered the drain ditch 52 is blocked by the partition 54 and entry of rainwater into the attachment groove 53 is inhibited.

Since the partition 54 includes the first side wall 54a, the second side wall 54b, and the coupling wall 54c, rainwater that has entered the drain ditch 52 is blocked by the first side wall 54a, the second side wall 54b, and the coupling wall 54c and entry of rainwater into the attachment groove 53 is inhibited.

Since the fixing members 9 include the fitting grooves 92 in which the rod members 81 can be fitted, the rod members 81 can be easily fixed to the fixing members 9.

Since the vehicle 100 includes the soft cab enclosures 8, the inside of the vehicle can be protected against wind, snow, rain, and other environments. Further, since the rod members 81 are fitted in the fitting grooves 92, the soft cab enclosures 8 can be easily fixed to the fixing members 9.

Since the antenna 5 is attached to the upper surface of the front roof 50, in the case of commonly using the front room 50 for different vehicle types, the antenna 5 can also be commonly used together with the front roof 50 so that this structure can easily fit different vehicle types.

Since the front roof 50 descends from the rear toward the front, the rear end portion 51 descends from the rear toward the front. Accordingly, even when rainwater enters between the rear end portion 51 and the front end portion 61, rainwater tends to move toward of the rear end portion 51 under its own weight. This can reduce entry of rainwater into the cabin from the rear of the rear end portion 51.

Since the rear roof 60 descends from the rear toward the front, rainwater on the rear roof 60 is caused to flow further forward under its own weight.

### First Variation

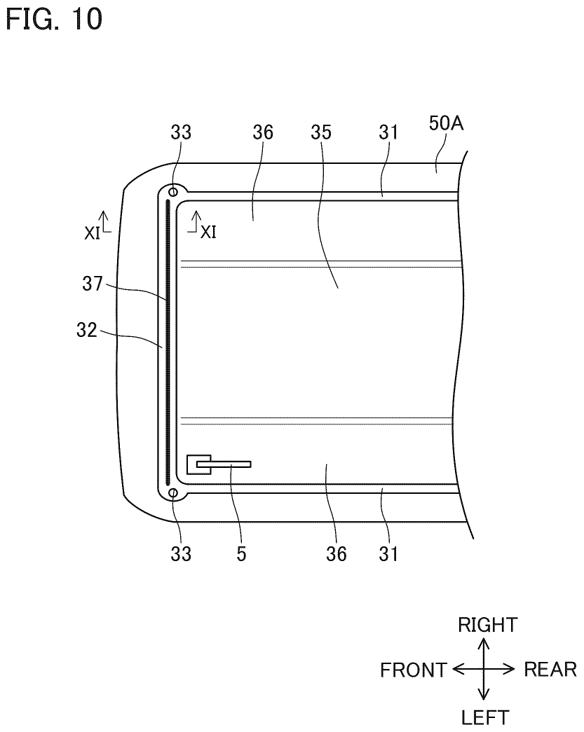

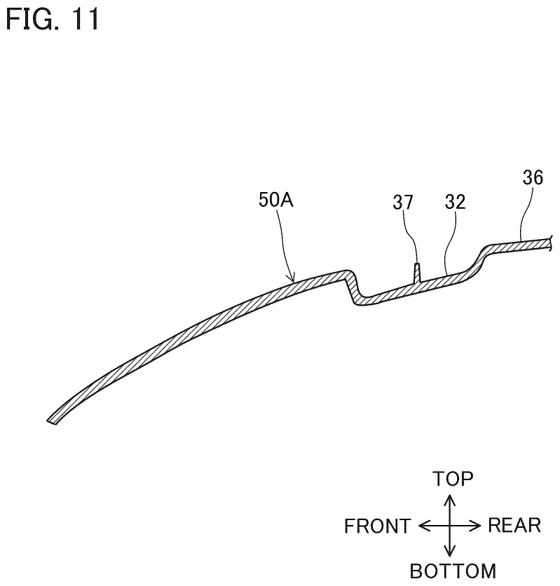

FIG. 10 is a plan view of a front roof of a vehicle (an example of a vehicle) according to a first variation when seen from above. FIG. 11 is a cross-sectional view taken along line XI-XI in FIG. 10.

The vehicle according to the first variation is different from the vehicle 100 according to the embodiment in a configuration of the front roof 50A. The following description will be directed mainly to a part of the configuration of the vehicle according to the first variation different from the vehicle 100 according to the embodiment. In the vehicle according to the first variation, the same reference characters as those of the vehicle 100 according to the embodiment denote the same components as those of the vehicle 100 according to the embodiment, and thus, description thereof will be omitted.

In the vehicle according to the first variation, a front roof 50A includes a second groove 32 extending in the vehicle width direction and a wall portion 37 located at the bottom of the second groove 32 and extending in the vehicle width direction. The wall portion 37 projects upward. The wall portion 37 is located between a left drain hole 33 and a right drain hole 33 in the vehicle width direction. The left end of the wall portion 37 is close to the left drain hole 33, and the right end of the wall portion 37 is close to the right drain hole 33. The wall portion 37 is located at the center of the second groove 32 in the front-rear direction. The wall portion 37 projects above a first surface 35 of the front roof 50A, and is located below second surfaces 36 of the front roof 50A.

In this configuration, since the front roof 50A includes the second groove 32 and the wall portion 37 located at the bottom of the second groove 32 and extending in the vehicle width direction, when rainwater enters the second groove 32 from the rear toward the front, rainwater that has entered the second groove 32 is blocked by the wall portion 37 and does not flow down from the front end of the front roof 50A, and flows along the second groove 32 to be discharged through the drain holes 33.

In the first variation, the wall portion 37 is located at the second groove 32 of the front roof 50A, but may be located at the second groove 32 of the rear roof 60 of the embodiment. Accordingly, when rainwater enters the second groove 32 of the rear roof 60 from the front toward the rear, rainwater that has entered the second groove 32 is blocked by the wall portion 37 and does not flow down from the rear end of the rear roof 60, and flows along the second groove 32 to be discharged. The first grooves 31 of the embodiment May include wall portions. In this case, the wall portions are located at the bottoms of the first grooves 31 and extend in the front-rear direction. Accordingly, in a case where rainwater enters the first grooves 31 from the center in the vehicle width direction outward in the vehicle width direction, rainwater that has entered the first grooves 31 is blocked by the wall portions and does not flow down from the left and right ends of the roof 3, and flows along the first grooves 31 to be discharged.

The description of other configurations, operations, and effects will be omitted, but the description of the vehicle 100 according to the embodiment can be used for the description of the vehicle according to the first variation.

### Second Variation

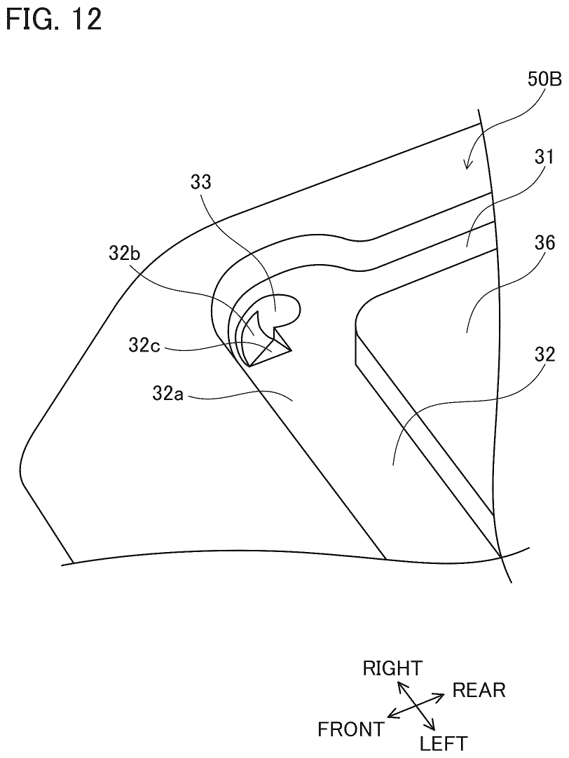

FIG. 12 is a perspective view of a front roof of a vehicle (an example of a vehicle) according to a second variation when seen from above the left front.

The vehicle according to the second variation is different from the vehicle 100 according to the embodiment in a configuration of the front roof 50A. The following description will be directed mainly to a part of the configuration of the vehicle according to the second variation different from the vehicle 100 according to the embodiment. In the vehicle according to the second variation, the same reference characters as those of the vehicle 100 according to the embodiment denote the same components as those of the vehicle 100 according to the embodiment, and thus, description thereof will be omitted.

In the vehicle according to the second variation, a front roof 50B includes a second groove 32 extending in the vehicle width direction and a drain hole 33 located at the bottom of the second groove 32. The bottom surface of the second grooves 32 includes a first surface 32a, a second surface 32b located below the first surface 32a and adjacent to the drain hole 33, and a third surface 32c connecting the first surface 32a and the second surface 32b to each other. That is, the bottom surface of the second groove 32 has a step structure that deepens toward the drain hole 33, near the drain hole 33. The first surface 32a and the second surface 32b are in parallel, for example. The first surface 32a and the second surface 32b are, for example, horizontal surfaces. The third surface 32c is, for example, a slope that declines toward the drain hole 33. The first surface 32a and the second surface 32b may not be in parallel. The first surface 32a and the second surface 32b may be slopes that decline toward the drain hole 33. The third surface 32c may be a surface orthogonal to the horizontal plane.

In this configuration, since the bottom surface of the second groove 32 includes the first surface 32a, the second surface 32b, and the third surface 32c, rainwater that has entered the second groove 32 flows down to the second surface 32b from the first surface 32a through the third surface 32c. Rainwater that has entered onto the second surface 32b is discharged through the drain hole 33 adjacent to the second surface 32b. In this manner, rainwater that has entered the second groove 32 can be easily guided to the drain hole 33.

Although the second variation is directed to the step structure of the bottom surface of the second groove 32 near the right drain hole 33, the bottom surface of the second groove 32 may have a step structure near the left drain hole 33. The second groove 32 of the rear roof 60 according to the embodiment may have drain holes 33 and the bottom surface of the second groove 32 may have step structures near the drain holes 33. In this manner, rainwater that has entered the second groove 32 can be easily guided to the drain holes 33.

The description of other configurations, operations, and effects will be omitted, but the description of the vehicle 100 according to the embodiment can be used for the description of the vehicle according to the second variation.

### Third Variation

Next, a vehicle (an example of a vehicle) according to a third variation will be described mainly with reference to FIGS. 1, 2, 7, 8, and 9. Unlike the vehicle 100 according to the embodiment, in the vehicle according to the third variation, a rear end portion 51 of a front roof 50 may not overlap a front end portion 61 of a rear roof 60 in the top-bottom direction, and the rear end portion 51 may not be located below the front end portion 61. That is, a positional relationship between the rear end portion 51 and the front end portion 61 is not limited. In the third variation, the same reference characters as those in the embodiment denote the same components, and thus, description thereof will be omitted.

The vehicle according to the third variation includes the front roof 50, the rear roof 60 located rearward of the front roof 50, and a fixing member 9 attached to at least one of the front roof 50 and the rear roof 60 and extending in the longitudinal direction, and a rod member 81 is allowed to be fixed to the fixing member 9. The fixing member 9 has a fitting groove 92 extending in the longitudinal direction and allowing the rod member 81 to be fitted therein. The vehicle according to the third variation may or may not include soft cab enclosures 8.

Since the vehicle according to the third variation includes the front roof 50 and the rear roof 60, the roof is regarded as having a split structure. Accordingly, in the case of manufacturing different types of vehicles, such as vehicles with different lengths in the front-rear direction, the front roof 50 or the rear roof 60 can be commonly used so that this structure can easily fit various vehicle types.

Since the fixing members 9 include the fitting grooves 92 in which the rod members 81 can be fitted, the rod members 81 can be easily fixed to the fixing members 9. For example, in the case of fixing the soft cab enclosures 8 including the rod members 81 to the fixing members 9, the soft cab enclosures 8 can be easily fixed to the fixing members 9. The members to be fixed to the fixing members 9 are not limited to the soft cab enclosures 8, and any member can be easily fixed to the fixing members 9 as long as the member includes the rod members 81.

The description of other configurations, operations, and effects will be omitted, but the description of the vehicle 100 according to the embodiment can be used for the description of the vehicle according to the third variation.

### Other Embodiments

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

The vehicle 100 may be a single-passenger vehicle. The vehicle 100 may include only one seat or three or more seats in the front-rear direction. The vehicle 100 may be a tricycle including three wheels, or may be a six-wheeled vehicle including six wheels.

The shape of the roof 3 is not limited. The roof 3 may be divided into three or more parts in the front-rear direction. In this case, in two divided parts adjacent to each other in the front-rear direction, the front divided part is defined as a front roof, and the rear divided part is defined as a rear roof.

Although the rear end portion 51 has a drain ditch 52, the drain ditch 52 may be omitted. In this case, the rear end portion 51 may have a flat shape without unevenness. Although the rear end portion 51 has the attachment groove 53, the attachment groove 53 may be omitted. In this case, the rear end portion 51 may have a flat plate shape without unevenness.

The soft cab enclosure 8 is located at each of the left and right in the vehicle width direction, but may be located at any one of the left and right in the vehicle width direction. Alternatively, the soft cab enclosure 8 may be additionally located at the rear in addition to the left and right. Alternatively, the vehicle 100 may include no soft cab enclosures 8.

The antenna 5 is attached to the upper surface of the front roof 50, but may be attached to the upper surface of the rear roof 60. Alternatively, the vehicle 100 may include no antenna 5.

The fixing members 9 may be individually attached to the front roof 50 and the rear roof 60, but only need to be attached to at least one of the front roof 50 and the rear roof 60.

The fixing members 9 are individually located at the front and the rear, but the front fixing member 9 and the rear fixing member 9 may be united. In the case where the soft cab enclosure 8 is located at the rear of the roof 3, the fixing member 9 may be located at the rear of the roof 3.

The front roof 50 descends from the rear toward the front, but may be horizontal. Alternatively, the front roof 50 may descend from the front toward the rear. In this case, drain holes 33 may be placed in a rear portion of the front roof 50 or the rear roof 60 so that rainwater is discharged through the drain holes 33.

The rear roof 60 descends from the rear toward the front, but may be horizontal. Alternatively, the rear roof 60 may descend from the front toward the rear. In this case, drain holes 33 may be placed in a rear portion of the rear roof 60 or the rear roof 60 so that rainwater can be discharged through the drain holes 33.

The vehicle of the present disclosure may be an off-road vehicle or an on-road vehicle. Examples of the off-road vehicle include a utility vehicle, a side-by-side vehicle, and a tractor.

### ASPECTS

The embodiments described above are specific examples of the following aspects.

### (First Aspect)

A vehicle (utility vehicle 100) includes: a front roof 50; and a rear roof 60 located rearward of the front roof 50, a rear end portion 51 of the front roof 50 overlaps a front end portion 61 of the rear roof 60 in a top-bottom direction, and the rear end portion 51 is located below the front end portion 61.

With this configuration, since the vehicle includes the front roof 50 and the rear roof 60, the roof is allowed to have a split structure. Accordingly, in the case of manufacturing different types of vehicles, for example, vehicles with different lengths in the front-rear direction, the front roof 50 or the rear roof 60 can be commonly used so that this structure can easily fit various vehicle types.

In addition, since the rear end portion 51 and the front end portion 61 overlap each other in the top-bottom direction, direct entry of rainwater into the cabin can be reduced.

Since the rear end portion 51 is located below the front end portion 61, in a case where each of the front roof 50 and the rear roof 60 descends from the rear toward the front, even when rainwater enters between the rear end portion 51 and the front end portion 61, entry of rainwater into the cabin can be reduced.

### (Second Aspect)

In the vehicle of the first aspect, the rear end portion 51 includes a drain ditch 52 that is open upward and extends in a vehicle width direction, and the drain ditch 52 overlaps a front end 61a of the front end portion 61 in the top-bottom direction.

With this configuration, since the drain ditch 52 of the rear end portion 51 overlaps the front end 61a of the front end portion 61 in the top-bottom direction, even when rainwater enters between the front end 61a of the front end portion 61 and the rear end portion 51, rainwater flows into the drain ditch 52 and is discharged along the vehicle width direction. This can further reduce entry of rainwater into the cabin.

### (Third Aspect)

In the vehicle of the first aspect or the second aspect, the drain ditch 52 includes a bottom wall 52a and a side wall 52b located forward of the bottom wall 52a and rising from the bottom wall 52a, a front end of the front end portion 61 includes a projection wall 62 projecting downward, and the projection wall 62 is inserted in the drain ditch 52 and faces the side wall 52b.

With this configuration, since the projection wall 62 is inserted in the drain ditch 52 and faces the side wall 52b, even when rainwater enters between the front end 61a of the front end portion 61 and the rear end portion 51, rainwater flows between the projection wall 62 and the side wall 52b to be guided to the drain ditch 52. This can further reduce entry of rainwater into the cabin.

### (Fourth Aspect)

In the vehicle of any one of the first through third aspects, the drain ditch 52 includes a bottom wall 52a, and the bottom wall 52a descends from a center in a vehicle width direction outward in the vehicle width direction.

With this configuration, since the bottom wall 52a descends from the center in the vehicle width direction outward in the vehicle width direction, rainwater that has entered the drain ditch 52 can be more reliably guided to the outer sides in the vehicle width direction.

### (Fifth Aspect)

In the vehicle of any one of the first through fourth aspects, each of the front roof 50 and the rear roof 60 includes a first groove 31 extending in a front-rear direction at each of left and right in a vehicle width direction, and the drain ditch 52 is connected to the first groove 31.

With this configuration, since the drain ditch 52 and the first groove 31 are connected to each other, rainwater that has entered the drain ditch 52 can be guided to the first groove 31.

### (Sixth Aspect)

The vehicle of any one of the first through fifth aspects further includes a fastening member 4 fastening the rear end portion 51 and the front end portion 61, and the fastening member 4 is located rearward of the drain ditch 52.

With this configuration, since the fastening member 4 is located rearward of the drain ditch 52, even when rainwater enters between the front end portion 61 and the rear end portion 51, rainwater is blocked by the drain ditch 52 and entry of rainwater into the fastening member 4 is inhibited. This can prevent corrosion of the fastening member 4.

### (Seventh Aspect)

In the vehicle of any one of the first through sixth aspects, the rear end portion 51 further includes an attachment groove 53 located rearward of the drain ditch 52 and a partition 54 partitioning the drain ditch 52 and the attachment groove 53, and the fastening member 4 is fastened to the front end portion 61 through the bottom wall 53a of the attachment groove 53.

With this configuration, since the rear end portion 51 includes the partition 54, rainwater that has entered the drain ditch 52 is blocked by the partition 54 and entry of rainwater into the attachment groove 53 is inhibited.

### (Eighth Aspect)

In the vehicle of any one of the first through seventh aspects, the partition 54 includes a first side wall 54a rising from a bottom wall 52a of the drain ditch 52 and defining the drain ditch 52, a second side wall 54b rising from the bottom wall 53a of the attachment groove 53 and defining the attachment groove 53, and a coupling wall 54c coupling the first side wall 54a and the second side wall 54b to each other.

With this configuration, since the partition 54 includes the first side wall 54a, the second side wall 54b, and the coupling wall 54c, entry of rainwater that has entered the drain ditch 52 into the attachment groove 53 is hindered by the first side wall 54a, the second side wall 54b, and the coupling wall 54c.

### (Ninth Aspect)

The vehicle of any one of the first through eighth aspects further includes a fixing member 9 attached to at least one of the front roof 50 and the rear roof 60 and extending in a longitudinal direction, the fixing member 9 allowing the rod member 81 to be fixed thereto, and the fixing member 9 includes a fitting groove 92 extending in the longitudinal direction and allowing the rod member 81 to be fitted therein.

With this configuration, since the fixing member 9 includes the fitting groove 92 in which the rod member 81 can be fitted, the rod member 81 can be easily fixed to the fixing member 9.

### (Tenth Aspect)

The vehicle of any one of the first through ninth aspects further includes a soft cab enclosure 8 shielding a cabin from outside the vehicle, the soft cab enclosure 8 includes the rod member 81 and a curtain 82 attached to the rod member 81, the rod member 81 is fitted in the fitting groove 92, and the soft cab enclosure 8 is fixed to the fixing member 9.

With this configuration, since the vehicle includes the soft cab enclosure 8, the inside of the vehicle can be protected against wind, snow, rain, and other environments. Since the rod member 81 is fitted in the fitting groove 92, the soft cab enclosure 8 can be easily fixed to the fixing member 9.

### (Eleventh Aspect)

The vehicle of any one of the first through tenth aspects further includes an antenna 5 attached to an upper surface of the front roof 50.

With this configuration, since the antenna 5 is attached to the upper surface of the front roof 50, in the case of commonly using the front room 50 for different vehicle types, the antenna 5 can also be commonly used together with the front roof 50, and this structure can easily fit different vehicle types.

### (Twelfth Aspect)

In the vehicle of any one of the first through eleventh aspects, at least one of the front roof 50 and the rear roof 60 descends from rear toward front.

With this configuration, in a case where the front roof 50 descends from the rear toward the front, the rear end portion 51 descends from the rear toward the front. Accordingly, even when rainwater enters between the rear end portion 51 and the front end portion 61, rainwater tends to move toward of the rear end portion 51 under its own weight. This can reduce entry of rainwater into the cabin from the rear of the rear end portion 51. On the other hand, in a case where the rear roof 60 descends from the rear toward the front, rainwater on the rear roof 60 is caused to flow further forward under its own weight.

### (Thirteenth Aspect)

In the vehicle of any one of the first through twelfth aspects, the front roof 50A includes a second groove 32 extending in a vehicle width direction and a wall portion 37 located at a bottom of the second groove 32 and extending in the vehicle width direction.

With this configuration, in a case where rainwater enters the second groove 32 from the rear toward the front, rainwater that has entered the second groove 32 is blocked by the wall portion 37 and does not flow down from the front end of the front roof 50A, and flows along the second groove 32 to be discharged.

### (Fourteenth Aspect)

In the vehicle of any one of the first through thirteenth aspects, the front-end front roof 50B includes a second groove 32 extending in a vehicle width direction and a drain hole 33 located at a bottom of the second groove 32, a bottom surface of the second groove 32 includes a first surface 32a, a second surface 32b located below the first surface 32a and adjacent to the drain hole 33, and a third surface 32c connecting the first surface 32a and the second surface 32b to each other.

In this configuration, since the bottom surface of the second groove 32 includes the first surface 32a, the second surface 32b, and the third surface 32c, rainwater that has entered the second groove 32 flows down to the second surface 32b from the first surface 32a through the third surface 32c. Rainwater that has entered the second surface 32b is discharged through the drain hole 33 adjacent to the second surface 32b. In this manner, rainwater that has entered the second groove 32 can be easily guided to the drain hole 33.

### (Fifteenth Aspect)

A vehicle (utility vehicle) includes: a front roof 50; a rear roof 60 located rearward of the front roof 50; and a fixing member 9 attached to at least one of the front roof 50 and the rear roof 60 and extending in a longitudinal direction, the fixing member 9 allowing a rod member 81 to be fixed thereto, and the fixing member 9 includes a fitting groove 92 extending in a longitudinal direction and allowing the rod member 81 to be fitted therein.

With this configuration, since the vehicle includes the front roof 50 and the rear roof 60, the roof is allowed to have a split structure. Accordingly, in the case of manufacturing different types of vehicles, for example, vehicles with different lengths in the front-rear direction, the front roof 50 or the rear roof 60 can be commonly used so that this structure can easily fit various vehicle types.

Since the fixing member 9 includes the fitting groove 92 in which the rod member 81 can be fitted, the rod member 81 can be easily fixed to the fixing member 9.

The invention claimed is:

1. A vehicle comprising:
a front roof; and
a rear roof located rearward of the front roof, wherein
a rear end portion of the front roof overlaps a front end portion of the rear roof in a top-bottom direction, and
the rear end portion is located below the front end portion.

2. The vehicle according to claim 1, wherein
the rear end portion includes a drain ditch that is open upward and extends in a vehicle width direction, and
the drain ditch overlaps a front end of the front end portion in the top-bottom direction.

3. The vehicle according to claim 2, wherein
the drain ditch includes a bottom wall and a side wall located forward of the bottom wall and rising from the bottom wall,
a front end of the front end portion includes a projection wall projecting downward, and
the projection wall is inserted in the drain ditch and faces the side wall.

4. The vehicle according to claim 2, wherein
the drain ditch includes a bottom wall, and
the bottom wall descends from a center in a vehicle width direction outward in the vehicle width direction.

5. The vehicle according to claim 2, wherein
each of the front roof and the rear roof includes a first groove extending in a front-rear direction at each of left and right in the vehicle width direction, and
the drain ditch is connected to the first groove.

6. The vehicle according to claim 2, further comprising
a fastening member fastening the rear end portion and the front end portion, wherein
the fastening member is located rearward of the drain ditch.

7. The vehicle according to claim 6, wherein
the rear end portion further includes an attachment groove located rearward of the drain ditch and a partition partitioning the drain ditch and the attachment groove, and
the fastening member is fastened to the front end portion through a bottom wall of the attachment groove.

8. The vehicle according to claim 7, wherein
the partition includes a first side wall rising from a bottom wall of the drain ditch and defining the drain ditch, a second side wall rising from the bottom wall of the attachment groove and defining the attachment groove, and a coupling wall coupling the first side wall and the second side wall to each other.

9. The vehicle according to claim 1, further comprising
a fixing member attached to at least one of the front roof and the rear roof and extending in a longitudinal direction, the fixing member allowing a rod member to be fixed thereto, wherein
the rod member includes a fitting groove extending in the longitudinal direction and allowing the rod member to be fitted therein.

10. The vehicle according to claim 9, further comprising
a soft cab enclosure that shields a cabin from outside the vehicle, wherein
the soft cab enclosure includes the rod member and a curtain attached to the rod member,
the rod member is fitted in the fitting groove, and
the soft cab enclosure is fixed to the fixing member.

11. The vehicle according to claim 1, further comprising
an antenna attached to an upper surface of the front roof.

12. The vehicle according to claim 1, wherein
at least one of the front roof and the rear roof descends from rear toward front.

13. The vehicle according to claim 1, wherein
the front roof includes a second groove extending in a vehicle width direction and a wall portion located at a bottom of the second groove and extending in the vehicle width direction.

14. The vehicle according to claim 1, wherein
the front roof includes a second groove extending in a vehicle width direction and a drain hole located at a bottom of the second groove, and
a bottom surface of the second groove includes a first surface, a second surface located below the first surface and adjacent to the drain hole, and a third surface connecting the first surface and the second surface to each other.

15. A vehicle comprising:
a front roof;
a rear roof located rearward of the front roof; and
a fixing member attached to at least one of the front roof and the rear roof and extending in a longitudinal direction, the fixing member allowing a rod member to be fixed thereto, wherein
the rod member includes a fitting groove extending in the longitudinal direction and allowing the rod member to be fitted therein.
